(19) United States
(12) Patent Application Publication
(10) Pub. No.: US 2016/0058247 A1
(43) Pub. Date: Mar. 3, 2016

(54) Dual Function Beverage Container and Mixing Apparatus

(71) Applicant: Michael Ryan Hogan, Sandy, UT (US)

(72) Inventor: Michael Ryan Hogan, Sandy, UT (US)

(21) Appl. No.: 14/831,672

(22) Filed: Aug. 20, 2015

Related U.S. Application Data
(60) Provisional application No. 62/043,242, filed on Aug. 28, 2014.

(51) Int. Cl. A47J 43/27

(52) U.S. Cl. CPC A47J 43/27

(57) ABSTRACT

A dual function beverage container and mixing apparatus is disclosed that can be assembled in a various configurations suitable for various functions in storing, transporting, dispensing, mixing and drinking beverages, such as, for example, mixed alcoholic and non-alcoholic cocktails. The dual function beverage container and mixing apparatus can have a container portion, an intermediate portion and a top portion. In a first configuration, the container portion, intermediate portion and top portion can be assembled to form a selectively re-sealable container, suitable to storing, transporting and/or dispensing a beverage. In a second configuration, the top portion and intermediate portion can be re-assembled to form a beverage shaker for mixing a beverage, such as, for example, a mixed alcoholic cocktail consisting of two or more ingredients.

### CROSS-REFERENCE TO RELATED APPLICATIONS

This application claims the benefit of U.S. Provisional Patent Application No. 62/043,242, entitled “DUAL FUNCTION BOTTLE BEVERAGE CONTAINER AND MIXING APPARATUS” and filed Aug. 28, 2014, which is incorporated herein by reference in its entirety.

### BACKGROUND

A mixed drink is a beverage in which two or more ingredients are combined. The mixed drink may be alcoholic or non-alcoholic, in which two or more liquids are typically mixed together. Ingredients may also include honey, fruit (e.g., lemons, limes, strawberries, etc.), sugar, dairy products, eggs, syrups, crushed ice, etc.

In making cocktails, a type of mixed drink, a jigger is a useful measuring tool for making exact measurements of the cocktail ingredients. Many jiggers contain two sides, a small side holding 1.5 ounces of liquid, and a larger side holding two ounces of liquid. In this manner, drinks that require ingredients with a 2:1.5 ratio are easily made. On the other hand, a cocktail in which the ingredients are only eyeballed, or in other words, measured by mere inspection, easily results in a drink that is too strong or too weak.

Additionally, cocktails may call for muddling, which entails putting an amount of one or more ingredients (e.g. fruit, herbs, etc.) in the bottom of a container for “muddling,” or mashing them, with a muddler or an end of a wooden spoon. In this manner, juices, oils, pulp, and/or bits may be sufficiently broken and thereby extracted.

Once the ingredients have been properly measured and/or muddled, the ingredients may be added to a cocktail shaker, a container for shaking. The shaker is closed with a cap and then the cocktail shaker is vigorously shaken by hand to combine the ingredients well. Afterward, the blended ingredients can then be strained and/or poured into an appropriate glass and the cocktail is ready for serving.

Preparing a cocktail or other mixed drink may be easier when the right tools are on hand, such as a mixing container, a measuring container, and/or a jigger. Also, preparing a cocktail may be easier when tools desired can easily be located. Preparing a cocktail may be easier when the tools used for preparation are easy to pack up for storing. Finally, preparing a cocktail may be easier when the tools for preparation are easily transported to social functions and gatherings.

### BRIEF SUMMARY

At parties and other social gatherings, friends and family often drink beverages, such as mixed drinks. In preparing a mixed drink, whether it be at home or at another location, it is helpful to have several tools on hand so that the mixed drink may be prepared properly. As disclosed herein, the invention is directed to a dual function beverage container and mixing apparatus that can be assembled in various configurations suitable for various functions in storing, transporting, dispensing, mixing and drinking beverages, such as, for example, mixed alcoholic cocktails. The dual function beverage container and mixing apparatus can have a container portion, an intermediate portion and a top portion. In a first configuration, the container portion, intermediate portion and top portion can be assembled to form a selectively re-sealable container, suitable for storing, transporting and/or dispensing a beverage. In a second configuration, the top portion and intermediate portion can be re-assembled to form a beverage shaker for mixing a beverage, such as, for example, a mixed alcoholic or non-alcoholic cocktail consisting of two or more ingredients. In addition, the top portion may incorporate one or more printed indicia or markings indicating one or more fluid measurements for measuring constituent ingredients and can also be used as a cup from which the beverage may be directly consumed. Further still, the intermediate portion can be used alone as a funnel to assist in transferring beverages from one container to another.

### BRIEF DESCRIPTION OF THE DRAWING

FIG. 1 is an elevation view of one embodiment of the invention assembled in a first configuration for storing and transporting a beverage.

FIG. 2 is an exploded view of the embodiment shown in FIG. 1.

FIG. 3 is a cross-sectional view of the embodiment shown in FIG. 1.

FIG. 4 is a detail view of selected portions of the embodiment shown in FIG. 1, reassembled to form a second configuration for mixing a beverage.

FIGS. 5A-5C are views of another embodiment of the invention.

### DETAILED DESCRIPTION

In preparing a mixed drink, whether at home, a social gathering, a traveling destination, or a family affair, it is helpful to have several kitchen tools that are readily available, easily located, easy to pack for storing, and easy to transport. Thus, the following implementations of the present disclosure comprise systems, methods, and apparatus for a dual function beverage container and mixing apparatus.

As disclosed herein, the invention is directed to a dual function beverage container and mixing apparatus that can be assembled in a various configurations suitable for various functions in storing, transporting, dispensing, mixing and drinking beverages, such as, for example, mixed alcoholic cocktails. The dual function beverage container and mixing apparatus can have a container portion, an intermediate portion and a top portion. In a first configuration, the container portion, intermediate portion and top portion can be assembled to form a selectively re-sealable container, suitable to storing, transporting and/or dispensing a beverage. In a second configuration, the top portion and intermediate portion can be assembled to form a beverage shaker for mixing a beverage, such as, for example, a mixed alcoholic cocktail consisting of two or more ingredients. In addition, the top portion may incorporate one or more printed indicia or markings indicating one or more fluid measurements for measuring constituent ingredients and can also be used as a cup from which the beverage may be directly consumed. Further still, the intermediate portion can be used alone as a funnel to assist in transferring beverages from one container to another.

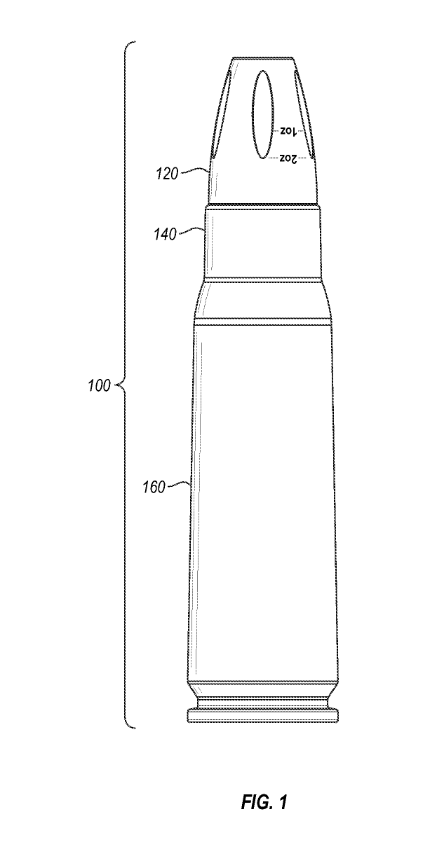

FIGS. 1-4 illustrate a first embodiment of a dual function beverage container and mixing apparatus 100 (“container/mixing apparatus”) with components that can include a top portion 120, an intermediate portion 140, an elongated cylindrical container portion 160 and a screw-top cap 180. Top portion 120, intermediate portion 140, and container portion 160 join together to form an integrated unit having properties and functionality to assist in storing and transporting a beverage. In addition, the various components can be separated, reoriented and reconnected to assist in measuring, mixing, dispensing and consuming beverages having two or more ingredients, such as, for example, alcoholic or non-alcoholic cocktails.

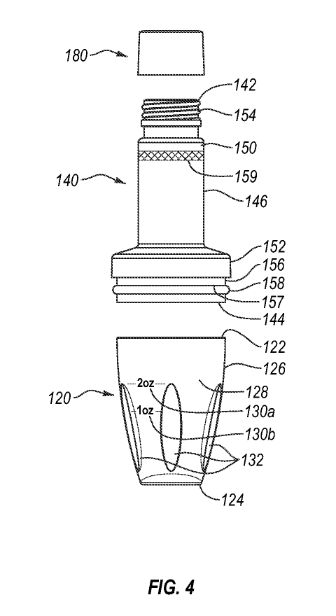

FIGS. 1-3 illustrate the container/mixing apparatus 100 assembled in a first configuration, wherein top portion 120, intermediate portion 140, container portion 160 and cap 180 are assembled to form a selectively re-sealable container, suitable to storing, transporting and/or dispensing a beverage. In this arrangement, container/mixing apparatus 100 provides an integrated and compact form factor. FIG. 4 illustrates a second configuration, in which top portion 120 and intermediate portion 140 can be re-assembled to form a beverage shaker for mixing cocktails consisting of two or more ingredients. Top portion 120 can also be separated from the other components, reoriented and used to measure various ingredients and can also be used as a glass or cup from which beverages can be directly consumed. Intermediate portion 140, with cap 180 removed, can also be separated from the other components, reoriented and used as a funnel to assist in transferring liquids from one container to another.

Referring generally to FIGS. 1-3, top portion 120 can have a generally circular base 122 forming a closed end, an open end 124, and side walls 126, with the closed end 122 and side walls 126 forming a reservoir 128. Top portion 120 can function as both a cover, lid or closure element and can also function as a cup from which beverages can be consumed. In other words, top portion 120 may be used to hold and/or measure liquids/ingredients and may also be inverted and used as a cover, lid, or closure element as illustrated in FIGS. 1-3.

Top portion 120 may also incorporate one or more indicia or markings 130, indicating one or more fluid measurements for measuring constituent ingredients. Top portion 120, or at least a portion thereof, may be transparent or sufficiently translucent so that the level of fluid contained within top portion 120 can be visually perceived through at least a portion of side walls 126. The markings 130 may consist of one or more printed markings, etched markings, ridges or recesses formed in the side walls 126, other visual or tactile means of marking or any combination of any of the forgoing options. As shown, in the embodiment illustrated in FIGS. 1-3, one marking 130a can be provided to indicate two fluid ounces and a second marking 130b can be provided to indicate one fluid ounce.

Top portion 120 can also include a mechanism for selectively attaching top portion 120 to intermediate portion 140. For example, the side walls 126 of top portion 120 may be configured so that the interior surfaces of side walls 126 engage a portion of the exterior surface of intermediate portion 140 in a press-fit engagement that securely affixes top portion 120 to intermediate portion 140, when desired, and yet is easily removable. More specifically, side walls 126 may include at least one or more protrusions 132 that may be radially spaced about and extend axially along a portion of the inner surface of side walls 126. Protrusions 132 may be sized and configured to press against at least a portion of an exterior surface of intermediate portion 140 to provide a friction fit attachment when the open end 124 of top portion 120 placed over intermediate portion 140. Protrusions 132 may be made of one or more of silicone, rubber, polymer, plastic, or combination thereof. The type of material used for the protrusions 132 may be selected to help provide a friction fit with intermediate portion 140. Alternatively, top portion 120 could have an annular recess (not shown) formed about the inner periphery of open end 124 that selectively engages a complementary ridge (not shown) formed about the periphery of the exterior surface of intermediate portion 140 in a snap-fit arrangement. In addition, other means known in the art can be readily adapted to selectively attach top portion 120 and intermediate portion 140.

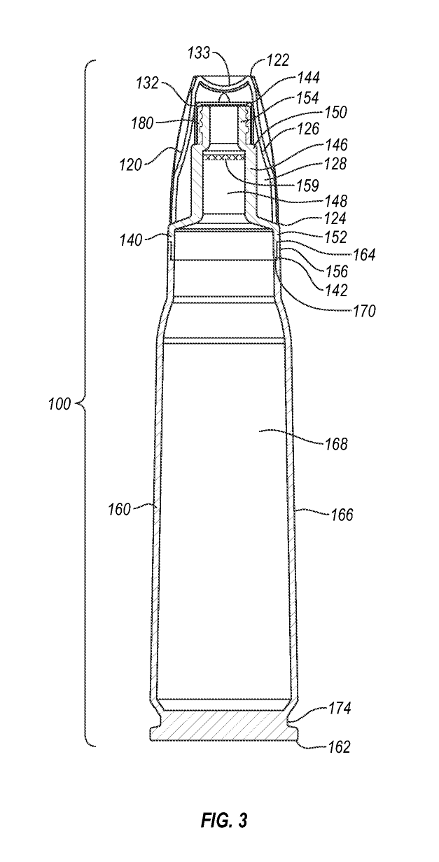

As shown in FIG. 3, the top portion 120 can also have a spherical protrusion 133 forming a dimple in the base 122 that extends into the interior of top portion 120. The protrusion or dimple 133 can be configured in such a way that its interior surface selectively engages and seals the distal end of the intermediate portion 140 when the apparatus is assembled in the first configuration.

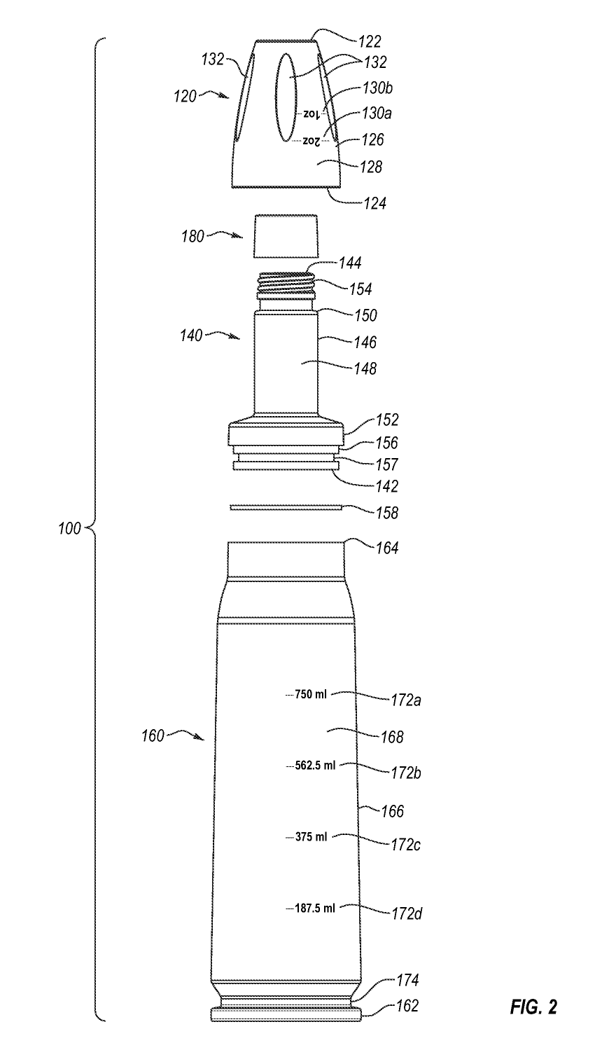

Referring next to intermediate portion 140, it can include a lower or proximal end 142 that is open, an upper or distal end 144, and side walls 146 that define a passageway 148 therebetween. Intermediate portion 140 can have an upper portion 150 and a lower portion 152, wherein lower portion 152 is relatively larger in diameter and cross-sectional area than upper portion 150. As shown, upper portion 150 may provide a neck or spout-like structure for pouring contents, such as liquids, from an assembly formed by intermediate portion 140 and container portion 160. The upper portion 150 may also include a threaded portion 154 at the distal end 144, as particularly shown in FIG. 2, which can mate with complementary threads formed in cap 180.

As also shown in FIG. 2, the lower portion 152 of intermediate portion 140 includes an area of reduced cross-sectional area 156 that is sized and shaped to selectively engage the upper or distal end of container portion 160 in sealing engagement. To provide a seal between the lower portion 152 of intermediate portion 140 and the upper portion of container portion 160, area 156 can include a notch 157 containing an o-ring 158. O-ring 158 may be sized and configured to provide a slip-fit, fluid tight seal when the lower portion 150 of intermediate portion 140 is inserted into the upper end of container portion 160. Alternatively, other means known in the art can be readily adapted for providing a means for selectively attaching intermediate portion 140 to container portion 160 in a fluid-tight manner. For example, intermediate portion 140 and container portion 160 could also include complementary threaded portions at their respective proximal and distal ends by which such connection is formed.

Intermediate portion 140 may also include a screen or filter 159 spanning a cross-sectional area within the passageway. Filter 159 can also be fitted into intermediate portion 140 in such a way that it is selectively removable by the user. If desired, filter 159 can be used to filter out particulate matter from beverages or other fluids as it passes through intermediate portion 140.

As will be apparent, when intermediate portion 140, container portion 160 and cap 180 are assembled together, they form a beverage container suitable to storing, transporting and dispensing liquid, such as a liquor or other alcoholic beverage. As discussed in additional detail below, however, intermediate portion 140 is adapted to perform additional functions. For example, intermediate portion 140 can be separated from container portion 160 and then be attached to top portion 120 to form a beverage shaker for mixing a beverage comprising two or more ingredients. In addition, intermediate portion 140 can be separated from the other components and, with cap 180 removed, can be inverted and used as a funnel to assist in transferring liquids from one container to another.

Referring next to container portion 160, it can include a lower or proximal end 162 that is closed, an upper or distal end 164 that is open, and side walls 166, wherein the closed proximal end 162 and side walls 166 define a reservoir 168 for holding a pre-selected volume of liquid. The distal end 164 can include a cut-out portion 170 that is configured in a manner to be complementary of, and selectively receive, the reduced section 156 of intermediate portion 140 in mating engagement. As alluded to above, when intermediate portion 140 and container portion 160 are coupled together in the configuration shown in FIGS. 1-3, o-ring 158 is compressed to provide a press-fit connection that is both secure and fluid-tight. However, other forms of connection that are known in the art can be adapted to form the connection between intermediate portion 140 and container portion 160 and are intended to fall within the scope of the invention.

As shown in FIG. 2, container portion 160 can also include one or more markings or indicia 172 to indicate one or more predefined fluid volumes, such as, for example, about 750 mL and/or subdivisions thereof. In such case, container portion 160, or at least a portion thereof, may be transparent or sufficiently translucent so that the level of fluid contained within container portion 120 can be visually perceived through side walls 166 or a portion thereof.

As alluded to above, the various components of container/mixing apparatus 100 can be selectively assembled in a variety of ways to perform various functions useful in preparing cocktails or other mixed beverages. In a first configuration as illustrated in FIGS. 1-3, top portion 120, intermediate portion 140, container portion 160 and cap 180 form a selectively re-sealable container, suitable to storing, transporting and/or dispensing a beverage. In a second configuration as illustrated in FIG. 4, top portion 120, intermediate portion 140 and cap 180 can be re-assembled to form a beverage shaker. For example, to prepare a single serving of a cocktail or other mixed drink, top portion 120 is removed from intermediate portion 140 and reoriented. With the open end 124 of top portion 120 facing up, top portion 120 can be used to measure various ingredients of a desired cocktail. For example, by referencing the indicia 130 provided on top portion 120, a desired amount of liquor can be poured into top portion 120 from the assembly formed by intermediate portion 140 and container portion 160. Then one or more additional ingredients, or mixers, can be added to top portion 120. The indicia 130 may also be useful in measuring the added mixers. Once the desired ingredients have all been placed into top portion 120, then intermediate portion 140 can be removed from container portion 160 and attached to top portion 120 to form a beverage shaker that can be used to thoroughly mix the ingredients contained therein. As further illustrated in FIG. 4, the open end 124 of top portion 120 receives the reduced section 156 of intermediate portion 140 in a press-fit engagement, with o-ring 158 interposed therebetween, to form fluid-tight seal between top portion 120 and intermediate portion 140. As with other connections previously discussed, other means known in the art can be readily adapted for providing a means for selectively attaching top portion 120 to intermediate portion 140 in a fluid-tight manner. For example, top portion 102 and intermediate portion 140 could also include complementary threaded portions at their respective ends by which such connection may be formed. Once the cocktail or other beverage has been thoroughly mixed, intermediate portion 140 can be removed from top portion 120 and the drink consumed directly from top portion 120. Alternatively, if desired, the beverage can be dispensed from the assembly formed by top portion 120 and intermediate portion 140 into a separate glass (not shown) by removing cap 180 and pouring the mixed beverage from the assembly into the separate glass through the distal end 144 of intermediate portion 140.

Container/mixing apparatus 100 can also be used to prepare multiple servings of a mixed beverage. In this case, the reservoir 168 of container portion 160 can be used to mix the beverage, and the combination of intermediate portion 140, container portion 160 and cap 180 can form a shaker assembly for mixing the beverage. In this case, with top portion 120 and intermediate portion 140 being removed from container portion 160, various ingredients can be added to container portion 160. By referencing the indicia 172 provided on container portion 160, a desired amount of liquor can be retained in container portion 160. Then one or more additional ingredients, or mixers, can be added to container portion 160. The indicia 172 may also be useful in measuring the added mixers. In addition, top portion 120 can be used to measure other ingredients and add them to the mix in container portion 160. Once the desired ingredients have all been placed into container portion 160, then intermediate portion 140 (with cap 180 in place) can be reattached to container portion 160 to form a beverage shaker that can be used to thoroughly mix the ingredients contained therein. Once mixed, cap 180 can be removed and the beverage dispensed through intermediate portion 140 into top portion 120 and/or one or more other beverage glasses for consumption. With the screen/filter 159 positioned within intermediate portion 140, screen/filter 159 can filter out unwanted particulate matter, such as fruit pulp, ice, etc., as the beverage is dispensed through intermediate portion 140.

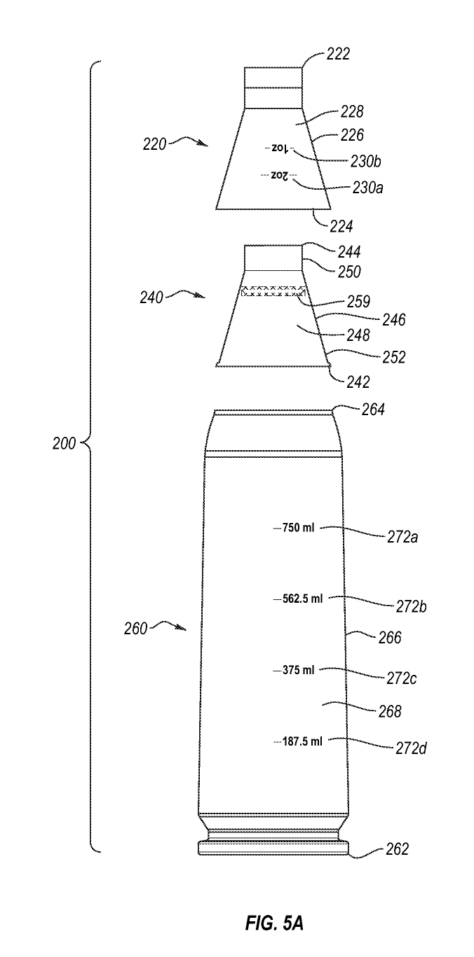

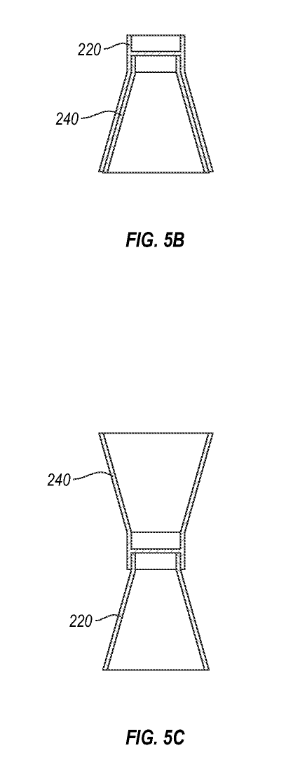

Turning next to FIGS. 5A-5C, another embodiment of container/mixing apparatus will be discussed. As shown, container/mixing apparatus 200 can have a top portion 220, an intermediate portion 240, and a container portion 260. The various elements of container/mixing apparatus 200 function in a manner similar to the corresponding components of the embodiment shown in FIGS. 1-4, and can also be reconfigured so as to perform tasks and functions in a manner very similar to that described above. The principal differences between this and the previous embodiment are the alternate configurations for top portion 220 and intermediate portion 240 as shown.

As shown in FIGS. 5A-5C, top portion 220 can have a base or closed end 222, an open end 224 and side walls 226 having a tapered profile with the diameter gradually increasing from the closed end 222 to the open end 224. The closed end 222 and side walls 226 define a reservoir 228. Top portion 220 can also provide a recess 234 formed in the closed end 222. Top portion 220 can also provide one or more indicia 230 to provide fluid measuring markings.

Intermediate portion 240 can have a lower or proximal end 242, an upper or distal end 244 and side walls 246 defining a passage 248 between ends 242 and 244. As shown, side walls 244 also have a tapered profile with the diameter gradually increasing from the distal end 244 to the proximal end 242. Intermediate portion 240 can also provide a neck portion 249 at distal end 244. Intermediate can also include a screen or filter 259 extending across passage 248, which may be selectively removable and which can be used for filter beverages and other liquids passing therethrough. The exterior profile of intermediate portion 240 closely approximates the interior profile of top portion 220 such that intermediate portion 240 closely nests within and attaches to top portion 220 when placed in a first configuration as shown in FIG. 5B.

Top portion 220 and intermediate portion 240 can also be combined in a second configuration as shown in FIG. 5C to form a “jigger.” For many mixed drinks, a jigger is used for quick and precise measurements. A jigger is a measuring device that commonly has an hourglass shape like two cups being attached back to back. With its tapered profile, the base 222 of top portion 220 may be attached to the distal end 244 of intermediate portion 240 to form the hourglass shape. Attachment may be a friction fit, screw fit, snap fit, or other means of attachment. A jigger typically has a 1.5 ounce measurement on one side and a 1 ounce measurement on the other side, which could be incorporated with top portion 220 and/or intermediate portion 140. For example, top portion 220 could have a 1.5 ounce fluid volume or could provide an indicia 230 indicating a 1.5 ounce fluid level within top portion 220, and intermediate portion 240 could provide a 1 ounce fluid volume or could provide an indicia indicating a 1.5 ounce fluid level within intermediate portion 240. Screen/filter 259 may be removable in forming a jigger.

Various other aspects and optional features may be incorporated into the container/mixing device that are not essential to provide the functionality described above. For example, the container/mixing device of the present invention may be embodied in any number of shapes and sizes. For example, one embodiment of the invention configured to hold one-fifth gallon or 750 milliliters of liquor may include the following approximate dimensions: an overall height of the complete assembly being about 12″; a diameter of container portion 160 or 260 being about 3″; a height of container portion 160 or 260 being about 6″ to 6.5″; a height of intermediate portion 140 or 240 being about 5.5″ to 6″; a diameter of the neck portion of intermediate portion 140 or 240 being about 1″; and a height of top portion 120 or 220 being about 3″ to 4″. The sizes of the various components can readily be proportionately adjusted to provide a container/mixing apparatus in different sizes, shapes and volumes.

In addition, other design elements may be incorporated into the present invention. It should, however, be noted that various design elements and other embellishments can be incorporated into the container/mixing apparatus of the present invention, without detracting from the form and function of the device. For example, as shown in FIG. 1, the container/mixing apparatus 100 may have an appearance, lines, and dimensions akin to a a bottle, such as a juice or wine bottle. Therefore, the container/mixing apparatus 100 may be conveniently stored among similarly sized juice and wine bottles, making it easy to gather most, if not all, beverage items in one place. Similarly, the outside profile of the container/mixing apparatus 100 may be smooth such that adjacent components join together to form a unitary assembly having a smooth, continuous profile. Alternatively, other distinctive shapes and appearances could be implemented, such as, for example, an implantation that is sized and shaped to be reminiscent of a bullet, as reflected in FIGS. 1-4. Such configuration may incorporate features and shapes commonly found in bullets, such as the casing, bullet slug, etc. Such design elements can be seen in the embodiment illustrated in FIGS. 1-4, wherein the overall shape of top portion 120 is reminiscent of a bullet slug and the overall shape of the visible portions of intermediate portion 140 and container portion 160 are reminiscent of an ammunition casing, complete an annular indention/groove 174 formed in the proximal end of container portion 160.

Structurally, groove 174 may optionally be used for purposes of storing. For example, a storage container (not shown) for the container/mixing apparatus 100 may be constructed like an ammunition magazine. A large version of a magazine-like holder could be used for multiple containers/apparatus 100 and/or beverage bottles for storing purposes. Such a design may include an interior ridge or other structure(s) located on an interior surface of the magazine that is used to align with groove 174 of the container/mixing apparatus 100.

In other alternatives, groove 174 could align with interior ridges or other structure(s) located within a carrying case, pantry, or wine rack. For a carrying case, one or more containers/apparatus 100 may have groove 174 aligned with an interior ridge within the carrying case. A pantry or a wine rack could have shelving with ridges that align with groove 174 and/or support the container/mixing apparatus 100.

As with size, shape and other design features, components of the container/mixing apparatus of the present invention can be fashioned from any suitable material that facilitates the functionality discussed above. Such materials may include, but not be limited to: glass, plastic, silicone, acrylic, ceramic, composite materials, wood, crystal, porcelain, metal or any combination thereof.

The invention is also directed to methods of preparing a beverage with a dual function beverage container and mixing apparatus, which may include one or more of the following steps: removing the top portion 120 from the intermediate portion 140; removing the intermediate portion 140 from the container portion 160; pouring at least one ingredient into the top portion 120 and using one of the indicia 130 to measure the amount of the at least one ingredient added to the top portion 120; adding one or more additional ingredients to top portion 120 and using one of the indicia 130 to measure the total amount of the combined ingredients contained in the top portion 120; attaching the proximal end 142 of the intermediate portion 140 to the open end 124 of the top portion 120 to form a beverage shaker assembly; shaking or agitating contents within the beverage shaker assembly: removing the lid 180 from the intermediate portion 140; and pouring the contents through the intermediate portion and thereby filtering the contents through the screen/filter 159 contained in the intermediate portion 140.

Alternatively, the methods of preparing a beverage with a dual function beverage container and mixing apparatus, which may include one or more of the following steps: removing the top portion 120 and the intermediate portion 140 from the container portion 160; using one or more indicia 172a-172d to measure a desired amount of a first ingredient within container portion 160; adding one or more additional ingredients to container portion 160 and using one or more of the indicia 172a-172d to measure the total amount of the combined ingredients contained in the container portion 160; attaching the proximal end 142 of the intermediate portion 140 to the upper end 164 of the container portion 160 to form a beverage shaker assembly; shaking or agitating contents within the beverage shaker assembly; removing lid 180 from intermediate portion 140; and pouring the contents through the intermediate portion and thereby filtering the contents through the screen/filter 159 contained in the intermediate portion 140.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A dual function beverage container and mixing apparatus, comprising:
a container portion having a proximal closed end and a distal open end and defining a reservoir;
an intermediate portion having an open proximal end and an open distal end and defining a passageway between the open ends, the proximal end of the intermediate portion being removably attachable to the distal end of the container portion; and
a top portion having a closed end and an open end, wherein
the apparatus has a first configuration in which proximal end of the intermediate portion engages the distal end of the container portion and the open end of the top portion is stacked on top of and engages the distal end of the intermediate portion to form a selectively re-sealable container suitable for storing, transporting and dispensing a beverage, and a second configuration in which the intermediate portion and the top portion are removed from the container portion and the proximal end of the intermediate portion is stacked on top of and engages the open end of the top portion to form a beverage shaker.

2. The apparatus of claim 1, wherein the top portion has at least one inner protrusion that extends axially along a portion of a wall of an interior cavity of the top portion, and wherein the inner protrusion is sized and configured to press against at least a portion of an exterior surface of the intermediate portion to provide a friction fit attachment when the top portion is placed on top of and removably attached to the distal end of the intermediate portion when the apparatus is assembled in the first configuration.

3. The apparatus of claim 1, further comprising a filter spanning a cross-sectional area within the passageway of the intermediate portion.

4. The apparatus of claim 1, intermediate portion further comprising:
a threaded portion adjacent the distal end of the intermediate portion; and
a cap having a threaded portion complementary to the threaded portion of the intermediate portion.

5. The apparatus of claim 1, wherein the container portion, the intermediate portion and the top portion are made of glass, acrylic, a polymer or combination thereof.

6. The apparatus of claim 1, wherein the top portion includes at least one marking that defines a volume of fluid contained within the top portion.

7. The apparatus of claim 6, wherein at least a portion of the top portion is transparent or translucent so as to permit the level of fluid contained in the top portion to be visually perceptible relative to the at least one marking.

8. The apparatus of claim 1, wherein the container portion includes at least one marking that defines a volume of fluid contained within the container portion.

9. The apparatus of claim 8, wherein at least a portion of the container portion is transparent or translucent so as to permit the level of fluid contained in the container portion to be visually perceptible relative to the at least one marking.

10. The apparatus of claim 1, wherein the top portion has a curved or angular projection from a bottom surface that selectively engages and seals the distal end of the intermediate portion when the apparatus is assembled in the first configuration.

11. The apparatus of claim 3, wherein the filter is attached to an annular surface of an interior wall of an upper section of the intermediate portion.

12. The apparatus of claim 3, wherein the filter that is attached to an annular surface of an interior wall of a lower section of the intermediate portion.

13. The apparatus of claim 1, wherein the top portion and the intermediate portion have tapered sides.

14. The apparatus of claim 1, wherein the open end of the top portion may be removably attached to the proximal end of the intermediate portion to form a beverage shaker.

15. The apparatus of claim 14, wherein an interior cavity of the top portion combines with an interior cavity of the intermediate portion to define a space for one or more of shaking, mixing, stirring, or containing of beverages or other mixtures.

16. The apparatus of claim 1, wherein a base of the top portion is configured to be removably attached to one of the ends of the intermediate portion to form a jigger.

17. The apparatus of claim 1, wherein removable attachment of the intermediate portion to the top portion and removable attachment of the intermediate portion to the container portion includes a press fit connection, a threaded connection, a snap fit connection, a friction fit connection, or combination thereof.

18. The apparatus of claim 1, wherein removable attachment of the intermediate portion to the top portion and removable attachment of the intermediate portion to the container portion includes one or more O-rings.

19. The apparatus of claim 1, wherein the intermediate portion can be selectively removed from the top portion and the container portion, reoriented, and used as a funnel.

20. The apparatus of claim 1, wherein the reservoir of the container portion has a volume for a fluid capacity of about 750 milliliters.
